(19) United States
(12) Patent Application Publication
(10) Pub. No.: US 2015/0193108 A1
(43) Pub. Date: Jul. 9, 2015

(54) Drag and Drop Downloading of Content Referenced by Displayed Elements

(71) Applicants: JIAN LI, Redmond, WA (US); ADAM R. de BOOR, Bainbridge Island, WA (US)

(72) Inventors: JIAN LI, Redmond, WA (US); ADAM R. de BOOR, Bainbridge Island, WA (US)

(21) Appl. No.: 13/194,824

(22) Filed: Jul. 29, 2011

Related U.S. Application Data
(60) Provisional application No. 61/369,491, filed on Jul. 30, 2010.

(51) Int. Cl. G06F 3/0486; G06F 17/22

(52) U.S. Cl. CPC G06F 3/0486; G06F 17/2247

(57) ABSTRACT

In a system and method for drag and drop downloading of content referenced by displayed elements, a browser application user interface that includes a web page rendered by the browser application is displayed. The displayed web page includes a displayed element that references content stored at a host external to the computer system. In response to a drag and drop of the displayed web page element to a displayed drop location that corresponds to a target application which is distinct from the browser application, content downloading instructions of the browser application are executed. As a result the referenced content is downloaded from the host to the target application.

### RELATED APPLICATION

This application claims priority to U.S. Provisional Application Ser. No. 61/369,491, filed Jul. 30, 2010, which is incorporated reference herein in its entirety.

### TECHNICAL FIELD

The disclosed embodiments relate generally to downloading content referenced by objects in a document. More particularly, the disclosed embodiments relate to drag and drop downloading of content referenced by displayed elements of a web page.

### BACKGROUND

Web pages include a variety of objects including static/dynamic images, text blocks, audio or video files, hypertext links to other websites, instructions, and the like. Users may copy certain displayed objects from a web page to their desktops by, for example, “right clicking” on the objects. Online electronic messaging applications allow users to open an attachment by clicking on the attachment. Downloading an attachment of an electronic mail message typically requires multiple user operations using the download manager of an email client or browser application.

### SUMMARY

Some embodiments provide a system, computer readable storage medium storing instructions, or a computer-implemented method for drag and drop downloading of content referenced by displayed elements of a web page. A client computer system displays a browser application user interface, including a web page rendered by the browser application. The displayed web page includes a displayed element that references content stored at a host external to the computer system. For example, the displayed element may represent an attachment to an email message displayed in the web page. The displayed web page element may be dragged to a displayed drop location that corresponds to a target application that is distinct from the browser application. In response to the drag and drop of the displayed web page element, content downloading instructions of the browser application are executed. As a result the referenced content is downloaded from the host to the target application.

### BRIEF DESCRIPTION OF THE DRAWINGS

FIGS. 1A-1B are block diagrams illustrating drag and drop downloading of content referenced by displayed web page elements, according to some embodiments;

FIG. 2 is a block diagram illustrating a distributed computer system, according to some embodiments;

FIG. 3 is a diagram illustrating a client computer system, according to some embodiments;

FIG. 4 is block diagram illustrating a host/server computer system, according to some embodiments;

FIG. 5 is a high level flow diagram of a method of drag and drop downloading of content referenced by displayed web page elements, according to some embodiments; and

FIGS. 6A-6D are flow diagrams of a method of drag and drop downloading of content referenced by displayed web page elements, according to some embodiments.

### DESCRIPTION OF EMBODIMENTS

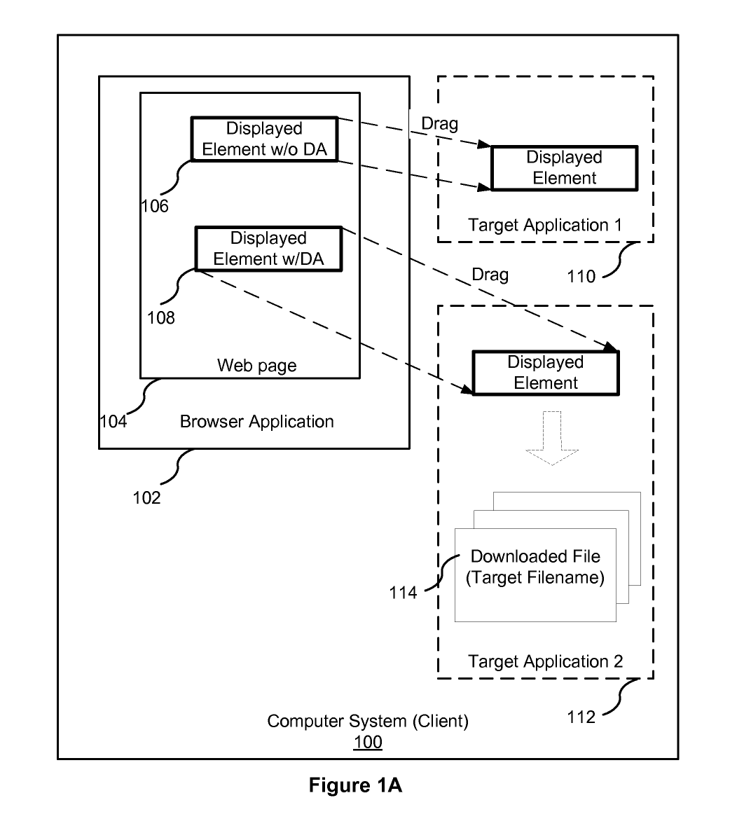

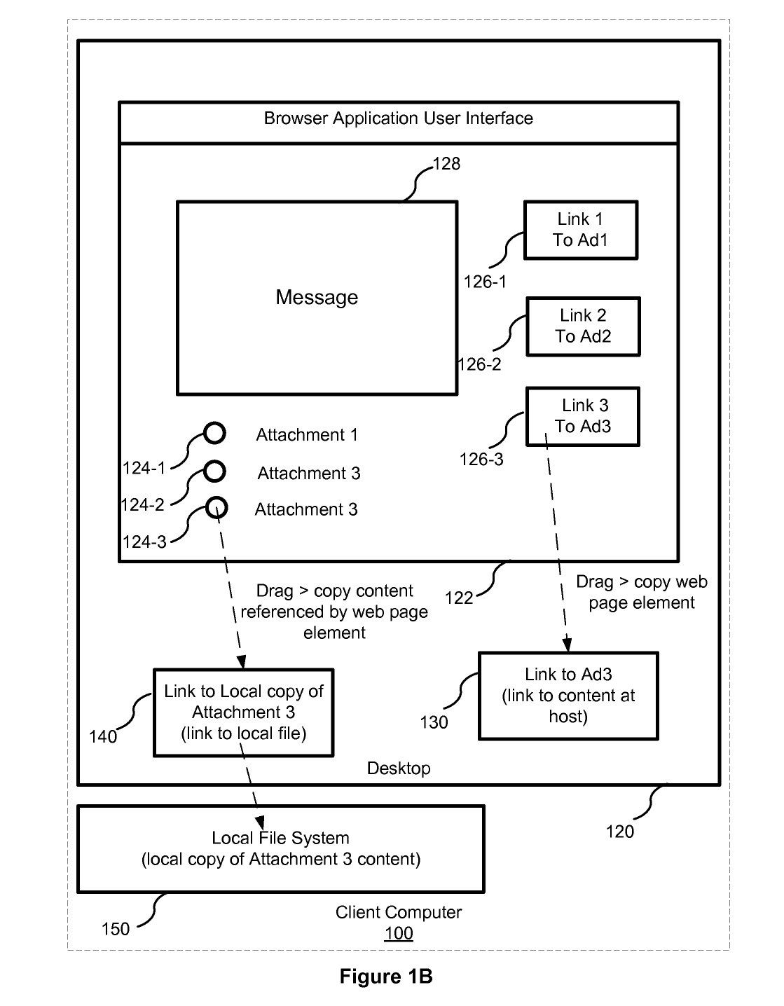

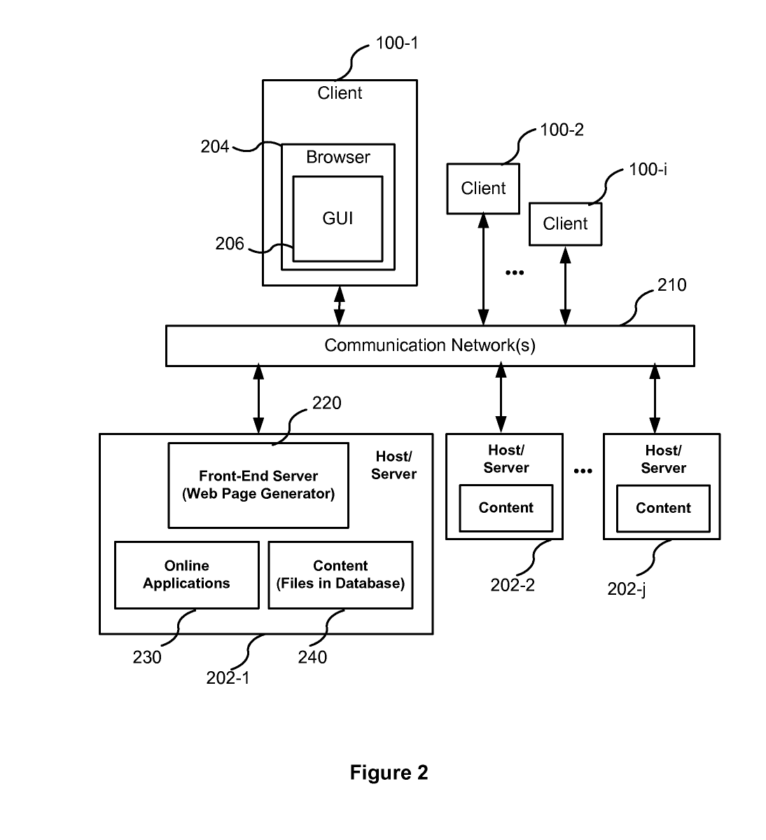

FIG. 1A is a block diagram illustrating drag and drop downloading of content referenced by displayed web page elements, according to some embodiments. At client computer system 100, web page 104 is requested and received from a host/server (e.g. host/server 202, FIG. 2). Web page 104 is rendered by browser application 102 and displayed by client computer system 100 (hereinafter “client 100” for ease of reference). Web page 104 includes one or more displayed elements, including, for example, displayed web page elements 106 and 108. Displayed web page element 108 references content (e.g., a web page or other file) stored in host/server 202, and web page element 106 is any object in web page 104. Host/server 202 is a distinct system from client 100. Typically, client 100 communicates with host/server 202 via a communications network. In some implementations, web page 104 includes embedded instructions (e.g., JavaScript code). When browser application 102 renders web page 104, browser application 102 executes the embedded instructions, if any, in web page 104.

In this example, web page element 108 has one or more download attributes (“DA”) while web page element 106 does not have download attributes. Download attributes are described in more detail below. For convenience, a web page element that has download attributes may be referred to as a “marked element,” and a web page element that does not have download attributes may be referred to as an “unmarked element.”

As shown in FIG. 1A, unmarked element 106 is dragged and dropped by a user from web page 104 to first target application 110, and marked element 108 is dragged and dropped by the user from web page 104 to second target application 112. First target application 110 and second target application 112 may be the same or different applications, but both first and second target applications 110, 112 are distinct applications from browser application 102. When unmarked element 106 is dragged and dropped by a user from web page 104 to first target application 110, first target application 110 receives a copy of unmarked element 106. If unmarked element 106 (e.g., an object, anchor tag, or the like) references content stored on a host (e.g., host/server 202, FIG. 2) external to client 100, unmarked element 106 itself is copied to first target application 110, but the referenced content is not copied to first target application 110.

On the other hand, when marked element 108 is dragged and dropped by a user from web page 104 to second target application 112, content referenced by marked element 108 is downloaded (e.g., from host/server 202, FIG. 2) to second target application 112. For example, if second target application 112 is a folder application, desktop application, or file manager application (sometimes called the “explorer” application on computers that use the Windows operating system, or the “Finder” application on Apple computers that use the Macintosh operating system) that shows the desktop or file folders or directories, file 114 containing the downloaded content is locally stored (in client 100) by second target application 112. In some embodiments, downloaded file 114 has a file name specified by the download attributes of marked element 108. In some embodiments, the file name specified by the download attributes is a suggested file name; the user or the target application can change the file name of the file in which the downloaded content is stored when predefined conditions prevail (e.g., if the specified file name is already used by another file at the same directory or folder as where the downloaded content is to be stored).

In some embodiments, as illustrated in FIG. 1B, drag and drop operations are performed on displayed elements in an online messaging application (e.g., an online email application, online chat application, etc.). Browser application user interface (UI) 122 shown in FIG. 1B includes message 128, attachment icons 124-1 to 124-3, and links 126-1 to 126-3. Attachment icons 124 correspond to (and typically identify) attachments to message 128 (e.g., an email message). Attachment icons in this example are links that reference content stored in host/server 202 of FIG. 2. Attachments icons 124 are marked elements having download attributes, and therefore dragging and dropping a respective attachment icon to desktop 120 results in downloading the content referenced by that attachment icon to a target file (i.e., a local copy of the attachment) in local file system 150 in client 100, and displaying link 140 to the local file on desktop 120.

Links 126 include links to three advertisements stored in host/server 202 (or alternatively stored in another host/server). These links are not marked elements and therefore do not have download attributes. Consequently, a drag and drop of any of links 126 (e.g., link 126-3) to desktop 120 results in displaying on desktop 120 link 130 to an advertisement (e.g., advertisement Ad3) stored in host/server 202, without downloading the content of the advertisement to client computer 100. Stated another way, a respective unmarked link 126 is a web page element, and the drag and drop of this element onto desktop 120 results in the desktop receiving a copy of the web page element, but does not result in corresponding content being downloaded from a host/server. In some embodiments, when the unmarked element (e.g., link 126) is dragged and dropped, the unmarked element is provided in multiple forms (e.g., HTML markup code, URL, plain text) to the target application (e.g., desktop 120 managed by a file manager application). The target application selects one of the provided forms and creates a representation of the unmarked element using the selected form.

FIG. 2 is a block diagram illustrating a distributed computer system, according to some embodiments. This system includes a number of client systems 100 (also called client computers, client devices, or clients), host/servers 202, and communication network(s) 210 for interconnecting these components. A respective client 100, such as client 100-1, includes browser application 204 with graphical user interface (GUI) 206. Client 100 sends a request for web page 104 (FIG. 1A) via communication network 210 to host/server 202. In response, host/server 202 retrieves web page 104 and sends it to client 100 via communication network 210. Browser application 204 renders the web page and GUI 206 displays the web page.

Although discussed in terms of web pages, the described embodiments are not limited to web pages and are applicable to other types of documents (e.g., XML documents) served to clients from various online applications.

In some embodiments, host/server 202 includes a front-end server 220, one or more online applications 230, and content 240. Front-end server 220 may include a web page generator that dynamically generates web pages in response to requests received from a respective client 100, using information from an online application 230 and/or one or more content databases 240. Examples of online applications 230 include online messaging applications, online document generating/processing applications, online media generating/processing applications, accounting applications, and the like. In some embodiments, content 240 includes one or more of messages (e.g., email messages in user accounts), attachments to messages (e.g., Web pages, PDF files, text files, image files, media file including audio/video files, etc.), documents or files of various types, and the like, stored in one or more databases.

In some embodiments, host/server 202 is implemented using a plurality of computer servers or processors. For instance, in a system that provides web pages for millions of users throughout the world, a distinct set of servers may be used to provide services to users in each of several distinct geographic regions of the world.

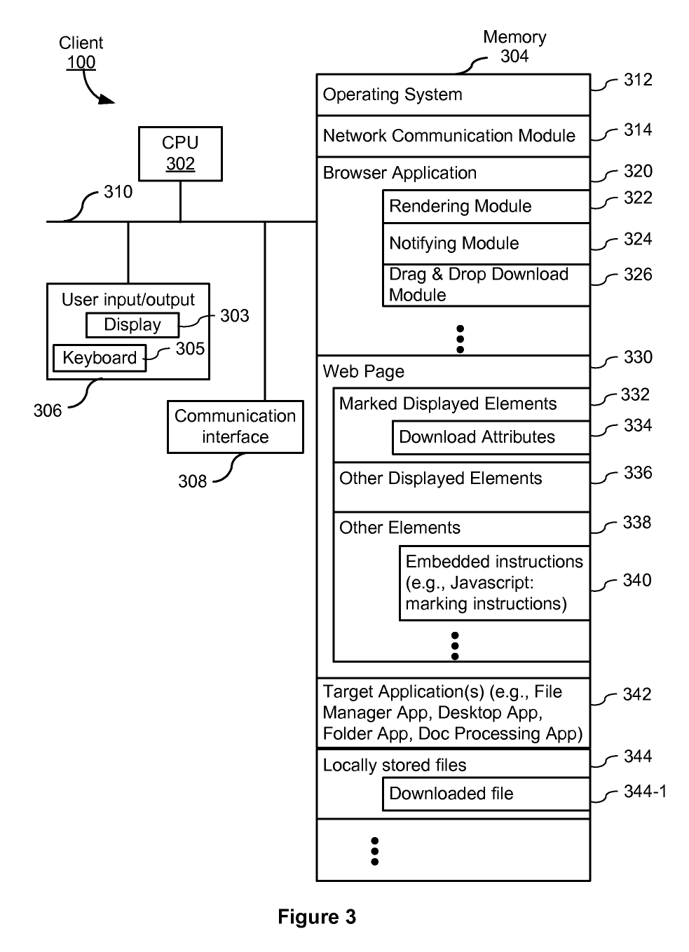

FIG. 3 is a diagram illustrating client 100, according to some embodiments. Client 100 generally includes one or more processing units (CPUs) 302, one or more network or other communication interfaces 308, memory 304, user input/output devices 306, and one or more communication buses 310 that interconnect these components. Optionally, the communication busses 310 include circuitry (sometimes called a chipset) that interconnects and controls communications between components of client 100. User input/output devices 306 may include display 303 (e.g., a touch-sensitive display), keyboard 305, and other components not shown in FIG. 3, such as mouse, touch pad, track ball, pointing stick, or any subset of these, and furthermore may optionally include other types of devices as well.

In some embodiments, memory 304 includes high-speed random access memory, such as DRAM, SRAM, DDR RAM or other random access solid state memory devices; and may also include non-volatile memory, such as one or more magnetic disk storage devices, optical disk storage devices, flash memory devices, or other non-volatile solid state storage devices. Memory 304 optionally includes one or more storage devices remotely located from the CPU(s) 302. Memory 304, or alternatively the non-volatile memory device(s) within memory 304, comprises a non-transitory computer readable storage medium.

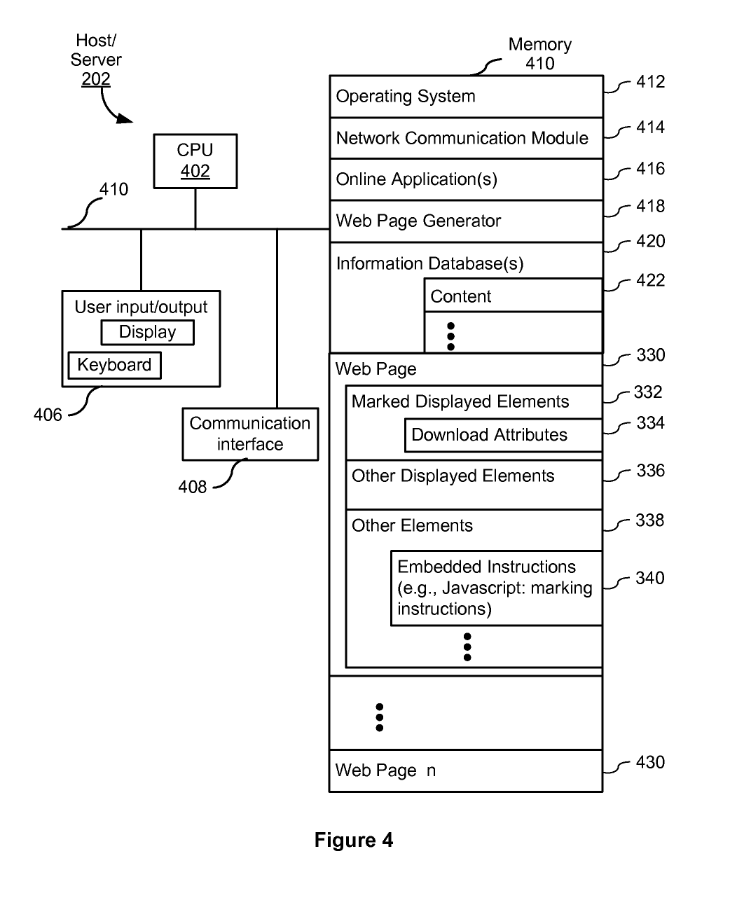

In some embodiments, memory 304 or the computer readable storage medium of memory 304 stores operating system 312 (e.g., LINUX, UNIX, or WINDOWS, or any other appropriate operating system), network communication module 314, browser application 320, web page 330, one or more target applications 342, and files 344, including a file 344-1 (sometimes herein called a downloaded file) stored in memory 304 or client 100 in response to a user-initiated drag and drop of a marked element in web page 330. Operating system 312 includes procedures for handling basic system services and for performing hardware dependent tasks. Network communication module 314 is used for communicating with external systems (e.g., server/host 202, FIGS. 2 and 4). Browser application 320 performs its operations via a number of modules. Example modules of browser applications 320 include:
Rendering module 322, which when executed by the CPU 302 renders web pages including web page 330. Rendering web page 330 includes executing embedded instructions 340, if any, that results in marking certain elements of web page 330, as identified in instructions 340, as download-enabled elements. Rendering web page 330 also includes displaying marked elements 332 and other elements 336 via display 303 of client 100.
Notifying module 324, which when executed by the CPU 302 notifies another browser application module, such as drag-and-drop download module 326, upon detection of a drag and drop of a displayed web page element, such as marked displayed element 332.
Drag-and-drop download module 326, which is executed by CPU 302 when a marked element, such as marked displayed element 332, is dragged and dropped by a user. The execution of drag-and-drop download module 326 results in downloading content 422 (of FIG. 4), which is referenced by marked displayed element 332, from its source in host/server 202 to target application 342.

Each of the above identified modules, applications or programs corresponds to a set of instructions, executable by the one or more processors 302 of client 100, for performing a function described above. The above identified modules, applications or programs (i.e., sets of instructions) need not be implemented as separate software programs, procedures or modules, and thus various subsets of these modules may be combined or otherwise re-arranged in various embodiments. In some embodiments, memory 304 may store a subset of the modules and data structures identified above. Furthermore, memory 304 may store additional modules and data structures not described above.

Web page 330 is received from host/server 202 in response to a request from client 100 and is rendered by browser application 320. Example components of web page 330 include:
One or more marked elements 332, which reference content 422 (FIG. 4) stored in a host/server remote from client 100. Dragging and dropping marked display element 332 to target application 342 results in downloading content 422 referenced by marked element 332 from its source in host/server 202 to target application 342. Marked element 332 includes associated download attributes 334. In some embodiments, download attributes 334 include a content type of the content, a target file name, and a URL that specifies the source of the content in host/server 202. The content type is typically specified by a respective MIME (Multipurpose Internet Mail Extension) type of the content, for example, application/pdf, image/jpg, image/tiff, or the like, as defined by the MIME standard. The target file name identifies a name of a target file to which the content is to be downloaded. The URL identifies the source of content 422 in host/server 202. The URL includes an address, which typically includes a host identifier and a path, and optionally includes one or more URL parameters.
Other displayed elements 336 include displayed elements that may or may not reference any content, but do not have download attributes. Dragging and dropping any one of other displayed elements 336 to target application 342 results in copying of the dragged-and-dropped element to target application 342, as described above with respect to FIGS. 1A and 1B.
Other elements 338 of web page 330 include elements that are not displayed to users, such as embedded instructions 340. In some embodiments, embedded instructions 340 include HTML code, JavaScript code, or the like.

In some embodiments, embedded instructions 340 include code that is executed when the web page is rendered by the browser application of a client 100. Upon execution, the code marks an element of web page 330, thereby creating a marked element. One example of this code is as follows:

var dragElem =
document.getElementById(“ID_Element_to_be_marked”);
dragElem.addEventListener(

“dragstart”,
function(event) {

event.dataTransfer.setData(“DownloadURL”,

“application/pdf:sample.pdf:http://example.com/example-download-
data”);

},
false

);

The above example of embedded instructions 340 adds download attributes to an element (“ID_Element_to_be_marked” is the identifier of the element in this example) of the webpage. Execution of this code causes this element to become a marked element of the web page, “document.” More specifically, the above code adds an event listener to the marked element. Web page 330 includes a separate instance of this code for each element of the web page that is to be marked with download attributes. Each instance of the code has a different identifier, identifying the element to be marked by that instance of the code, and parameters specific to that marked element.

In the code example above, the object called “document” is the object form of web page 330, after the browser application has parsed the web page.

The event listener added to the marked element has several parameters. These parameters include a triggering condition (“dragstart,” which is the start of a drag and drop operation) that triggers the event listener, and a function to call when the event is dispatched. The “dragstart” event is an object with multiple properties, including the element on which the event was generated, and a “dataTransfer” object that stores information about the item being dragged. This information includes the set of formats in which the item is available. The set can be expanded by calling the “setData” function on the “dataTransfer” object. The event listener in the above example do this by adding the “DownloadURL” format to the set of formats for the marked element. The DownloadURL format is used by the browser to represent the item represented by the marked element, to other applications, as a file that can be dropped on them. A file is represented as a file type, a file name, and data. In the setData function call shown above, the file value is a string of the form “type:name:url”. When the marked element is dragged and dropped on an application, the application consults the set of available formats and requests the item represented by the marked element in the format that the application wishes to use. The browser fetches the data from the server using the URL specified by the setData function and provides the data in the format requested by the application.

In some implementations, target applications 342 include, for example, one or more of a desktop application, a folder application, a file manager application, a document generating/processing application, and a media generating/processing application, such as an application that produces or edits audio, video or other media content.

Although FIG. 3 shows client 100 as a number of discrete items, FIG. 3 is intended more as a functional description of the various features which may be present in client 100 rather than as a structural schematic of the embodiments described herein.

FIG. 4 is block diagram illustrating host/server 202, according to some embodiments. For sake of brevity, the descriptions of aspects of FIG. 4 that are analogous to those in FIG. 3 are omitted here. Web pages in host/server 202, such as web page 330 and 430, are sent, upon request, to one or more clients 100, via communications network 210 (FIG. 2). In some embodiments, web pages 330 and 430 are generated by web page generator 418 in response to requests received from clients 100. In some implementations, these web pages are constructed by accessing information in one or more information database(s) 420, which are located in the same server or in one or more other servers. In some embodiments, web pages 330, 430 provide access to online applications 416, which are analogous to online applications 230 of FIG. 2. In some embodiments, online applications 416 include an online messaging application (e.g., online email application, etc.).

Information databases 420 retain server side information, including content 422. In some embodiments, content 422 includes one or more messages (e.g., email messages in user accounts), attachments to messages (e.g., Web pages, PDF files, text files, image files, media file including audio/video files, etc.), documents, or files of various types. One or more marked elements 332 of web page 330 reference content 422. When a user of client 100 drags and drops such elements, content 422 is downloaded to client 100 as will be described in more detail below.

Although FIG. 4 shows host/server 202 as a number of discrete items, FIG. 4 is intended more as a functional description of the various features which may be present in host/server 202 rather than as a structural schematic of the embodiments described herein. The actual number of servers in host/server 202 and how online applications 416, content 422, web pages 330 and the like are allocated among them will vary from one implementation to another, and may depend in part on the amount of data traffic that the system must handle during peak usage periods as well as during average usage periods.

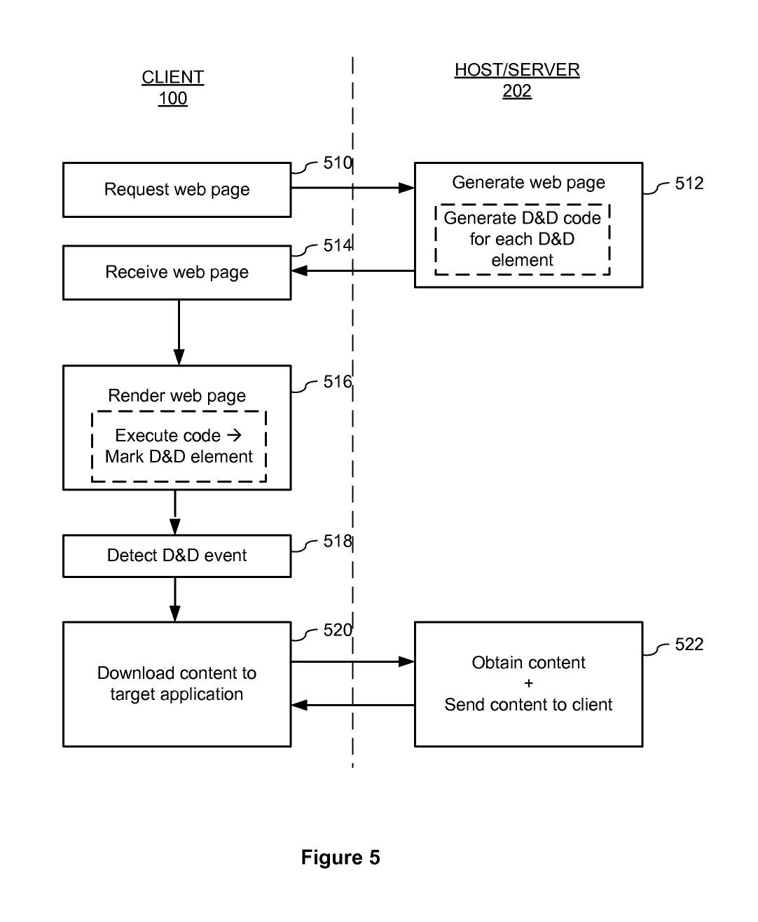

FIG. 5 is a high level flow diagram of a method of drag and drop downloading of content referenced by displayed web page elements, according to some embodiments. At client 100, when a user activates a link to a web page (e.g., web page 330, FIG. 3), client 100 sends a HTTP request for the web page to host/server 202 (510).

In response to the request from client 100, host/server 202 generates the requested web page (or obtains the web page from storage, if the web page was previously generated) and sends the requested web page to client 100 (512). In some embodiments, the requested web page is generated by web page generator 418 (FIG. 4). The requested web page typically includes one or more displayed elements (i.e., enabled for displaying by a browser application, such as browser application 320 (FIG. 3)). One or more of the displayed elements reference content (e.g., content 422, FIG. 4) stored in host/server 202. A drag and drop of any of these displayed elements (also called “drag-and-drop elements”) will result in copying of a link to the referenced content or downloading the referenced content, depending on whether the dragged-and-dropped element is marked or not, from host/server 202 to a drop location, such as a target application (e.g., target application 342 of FIG. 3). When generating the requested web page, host/server 202 generates respective embedded instructions (e.g., embedded instructions 340, FIG. 3) for each drag-and-drop element and embeds the embedded instructions in the web page. Host/server 202 then sends the generated web page along with a HTTP response to client 100. As described above, communications between host/server 202 and client 100 are performed via communication network(s) 210 (FIG. 2).

Client 100 receives the web page from host/server 202 (514) and renders the web page using rendering module 322 of FIG. 3 (516). When rendering the web page, rendering module 322 executes the embedded instructions embedded in the web page. The embedded instructions identify one or more elements of the web page that are to be modified so that they become download-enabled elements, also herein called marked elements. When the embedded instructions are executed, the identified web page elements are “marked” by adding download attributes to the identified elements. Notifying module 324 (FIG. 3) detects a drag-and-drop of a marked element (518), herein called a drag-and-drop event and notifies drag-and-drop download module 326 (FIG. 3) of the drag-and-drop event. Stated another way, notifying module 324 generates a notification that is received by drag-and-drop download module 326. Drag-and-drop download module 326 then sends a request for content referenced by the marked element to host/server 202 (520). Host/server 202 accesses information database(s) 420 of FIG. 4 to obtain the content and sends the obtained content to client 100 (522). Client 100 receives the content and saves it to a target file identified by the download attributes of the marked element (e.g., “sample.pdf”, as described above with respect to FIG. 4).

In some embodiments, when a drag-and-dropped element references content in host/server 202, but the drag-and-dropped element is not a marked element (e.g., the element does not have download attributes), the content referenced by the drag-and-drop element is not downloaded. Instead, the drag-and-dropped element of the web page is copied to the drop location (e.g., a target application such as target application 110 of FIG. 1). For example, if the drag-and-dropped element is a thumbnail image that references a larger-scale image at host/server 202, only the thumbnail image is copied to target application 110.

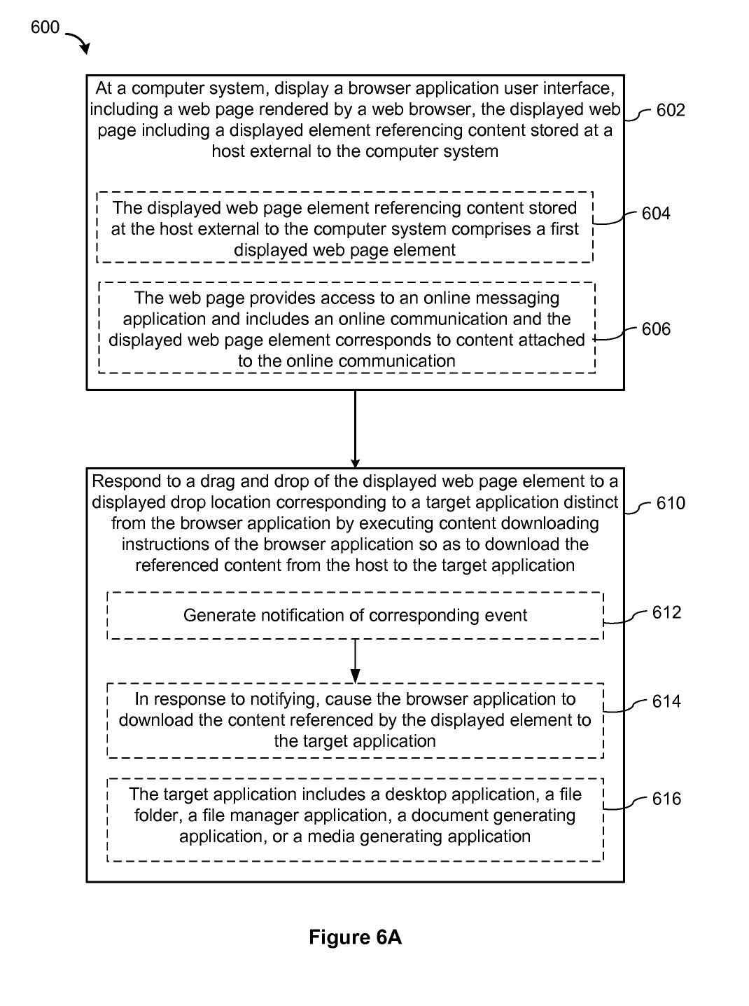

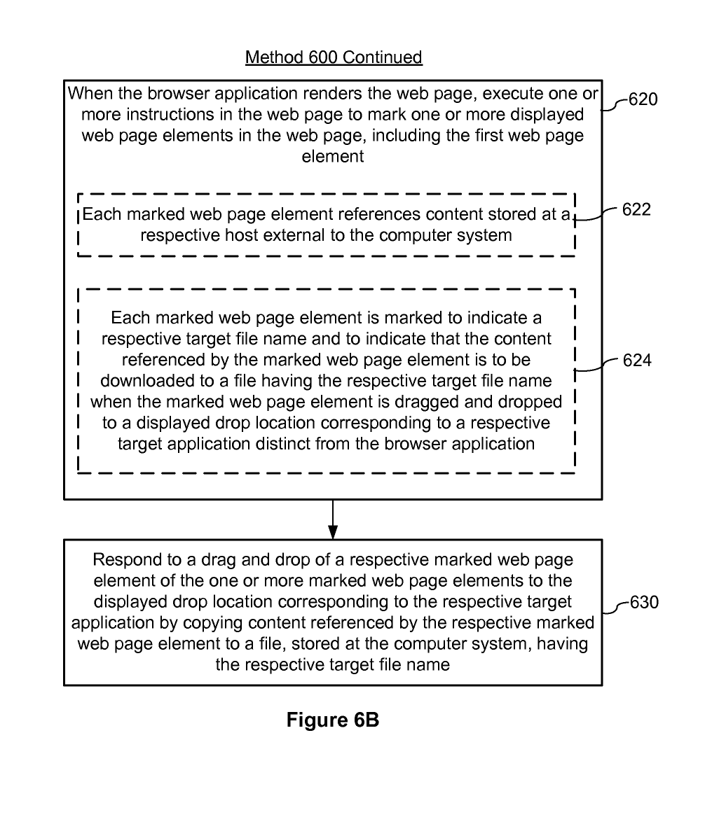

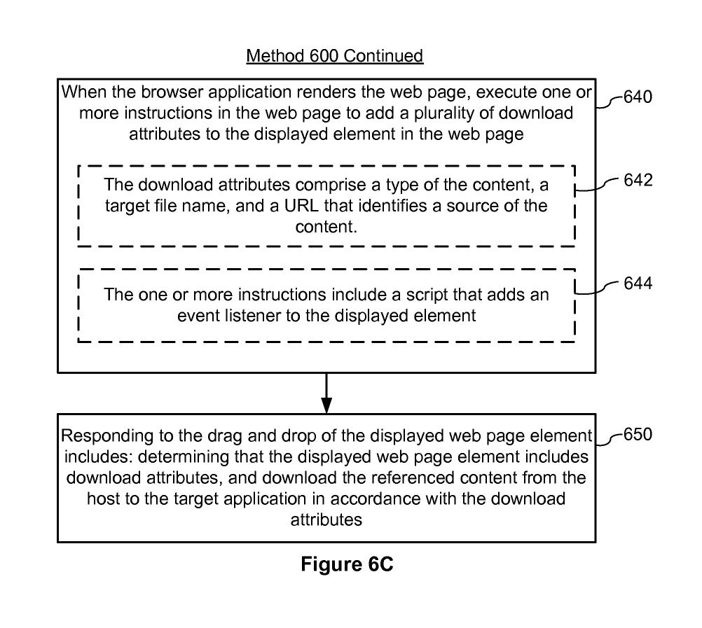

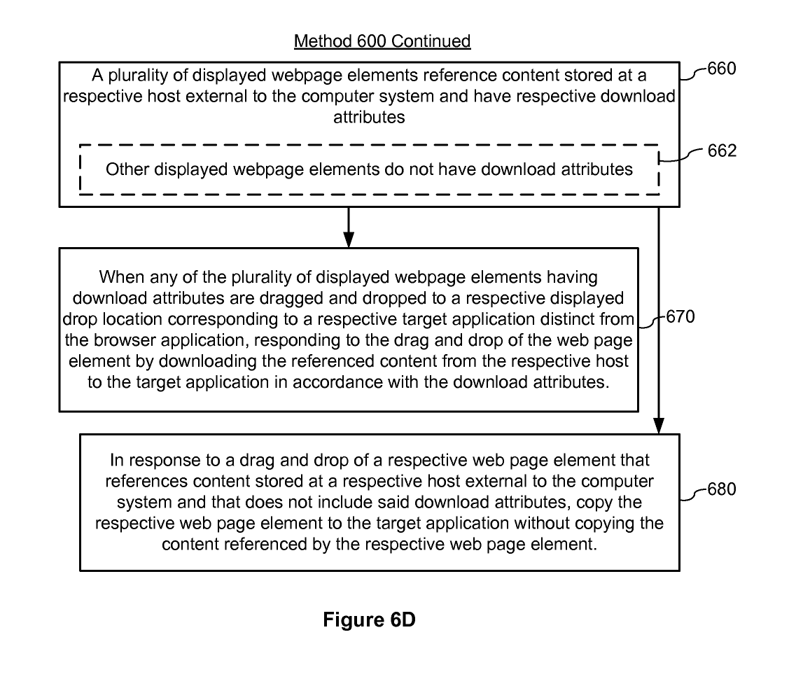

FIGS. 6A-6D are flow diagrams of a method 600 of drag and drop downloading of displayed web page elements, according to some embodiments. In some implementations, method 600 is performed by a client (e.g., client 100, FIG. 3), under the control of instructions stored in memory (e.g., memory 304, FIG. 3) that are executed by one or more processors (e.g., processor 302, FIG. 3). The operations shown in FIGS. 6A-6D correspond to computer readable instructions stored in a computer readable storage medium of memory 304. The computer readable instructions are in source code, assembly language code, object code, or other instruction format that is interpreted and/or executable by the one or more processors 302.

A computer system (e.g., client 100) displays (602) a browser application user interface, including a web page rendered by the browser application. The displayed web page includes a displayed element referencing content stored at a host external to the computer system. For example, client 100 displays browser application GUI 206 (FIG. 2), including displaying web page 330 (FIG. 3) rendered by browser application 320 (FIG. 3). Displayed web page 330 includes displayed element 332 that references content 422 (FIG. 4) stored at host/server 202 (FIG. 4) external to client 100.

To make it easier in the following discussion to distinguish between web page elements, the displayed web page element referencing content stored at the external host is sometimes called a first displayed web page element (e.g., email attachment icons 124) (604).

In some embodiments, the web page provides access to an online messaging application and includes an online communication, and the displayed web page element corresponds to content attached to the online communication (606). For example, web page 330 provides access to an online messaging application (e.g., Gmail, Yahoo! Mail, Twitter, etc.) and includes an online communication, such as an email message, a SMS message, a tweet, a blog post or comment, a chat, and the like.

The computer system responds to a drag and drop of the displayed web page element to a displayed drop location corresponding to a target application, which is distinct from the browser application, by executing content downloading instructions of the browser application so as to download the referenced content from the host to the target application (610). For example, browser application 320 responds to a drag and drop of the displayed web page element (e.g., marked displayed element 332, FIG. 3) to a displayed drop location corresponding to a target application (e.g., target application 342) distinct from browser application 320 by executing content downloading instructions (e.g., drag-and-drop download module 326, FIG. 3). The execution of these instructions results in downloading content 422 referenced by the dragged-and-dropped displayed web page element from host/server 202 to target application 342.

In some embodiments, responding to the drag and drop of the displayed web page element includes generating a notification (612) of a corresponding event (e.g., a “dragstart” event, which occurs at the beginning of the drag and drop, or a “dragend” event, which occurs at the end of the drag and drop), and, in response to the notification, causing (614) the browser application to download the referenced content to the target application. For example, notifying module 324 (FIG. 3) notifies drag-and-drop download module 326 (FIG. 3) of browser application 320 regarding the drag-and-drop event. In response to the notification generated by notifying module 324, drag-and-drop download module 326 causes browser application 320 to download content 422 referenced by the displayed element to target application 342. In some embodiments, the target application (e.g., target application 342, FIG. 3) is a desktop application, a folder application (sometimes called a file folder application or a file folder), a file manager application, a document generating application, or a media generating application (616).

In some embodiments, when the browser application renders the web page, the computer system executes one or more instructions embedded in the web page to mark one or more displayed web page elements in the web page, including the aforementioned first displayed web page element (620). Each marked web page element references content stored at a respective host external to the computer system (622). Each marked web page element is marked to indicate a respective target file name and to indicate that the content referenced by the marked web page element is to be downloaded to a file having the respective target file name when the marked web page element is dragged and dropped to a displayed drop location corresponding to a respective target application distinct from the browser application (624).

For example, when browser application 320 renders web page 330, it executes one or more instructions (e.g., embedded instructions 340) in web page 330 to mark one or more displayed web page elements in web page 330. In one example, the displayed web page element that is marked is an email attachment icon 124 (FIG. 1B). Each marked email attachment icon references content (e.g., a file or other attachment) stored at a respective host (e.g., host/server 202) external to client 100. The marked email attachment icon has download attributes, including a download attribute that indicates a respective target file name. The download attributes of the marked email attachment icon also indicate that the content referenced by marked displayed elements 332 is to be downloaded to the client and stored in a file having the respective target file name, when the marked email attachment icon is dragged and dropped to a displayed drop location corresponding to a respective target application (e.g., target application 112, FIG. 1A) distinct from the browser application.

In some embodiments, the computer system responds to a drag and drop of a respective marked web page element of the one or more marked web page elements to the displayed drop location corresponding to the respective target application by copying content referenced by the respective marked web page element to a file, stored at the computer system, having the respective target file name (630). For example, browser application 320 responds to a drag and drop of a marked email attachment icon to the displayed drop location corresponding to the respective target application by copying the attachment (content 422) referenced by the marked email attachment icon to a file, stored at the client 100, having the respective target file name. As noted above, the respective target file name is identified by the download attributes of the marked web page element. In this example, the target file name is typically the same as, or includes, the name of the attachment displayed in the rendered web page.

In some embodiments, when the browser application renders the web page, the computer system executes one or more instructions in the web page to add a plurality of download attributes to the displayed element (e.g., an email attachment icon) in the web page (640). For example, when browser application 320 renders web page 330, browser application 320 executes one or more embedded instructions 340 (FIG. 3) in web page 330 to add a number of download attributes 334 (FIG. 3) to a displayed email attachment icon in a web page used to access email messages.

In some embodiments, the download attributes added to a displayed web page element include a type of the content, a target file name, and a URL that identifies the source of the content (642). Each of these parameters is described in more detail above.

In some embodiments, the one or more instructions include a script that adds an event listener to the displayed web page element that is being marked (644). For example, embedded instructions 340 include code that adds an event listener to the displayed web page element, as described above with respect to FIG. 3.

In some other embodiments, embedded instructions 340 include code that adds a new method (e.g., “downloadUrl”) to a document object model element (DOM element) (e.g., a displayed element) to mark that element as download enabled, as follows:

var dragElem = document.getElementById(“drag”);

dragElem.downloadUrl(“application/pdf”, “sample.pdf”,

“http://example.com/example-download-data”);

In the above code, a variable called “dragElem” represents the element to be marked. The function downloadURL is added to this element of the document. The parameters “application/pdf,” “sample.pdf”, and “http://example.com/example-download-data”) are download attributes 334 (FIG. 3), which in this case are parameters of the downloadURL function. In the example given above, the download attributes are the MIME type of the content 422 to be downloaded, the target file name of the file in which the downloaded content is to be stored, and the URL of the source of content 422.

In some other embodiments, embedded instructions 340 include code that adds one or more download attributes to an HTML anchor tag/element (e.g., displayed web page element 108 of FIG. 1A). For example, the following code adds new download attributes, such as “dragMimeType” and “dragSaveAs,” to an anchor HTML element “<a>” (e.g., a displayed element):

<a href=“http://example.com/example-download-data”

dragMimeType=“application/pdf” dragSaveAs=“sample.pdf”>

<img src=“http://example.com/example-icon.gif”>

</a>

The “dragMimeType” and “dragSaveAs” attributes define the MIME type and the target file name as “application/pdf” and “sample.pdf”. The source of the content 422 referenced by the displayed element (i.e., “<a>”) is the URL “http://example.com/example-download-data.” The other URL, “http://example.com/example-icon.gif,” is the URL for an image to be displayed in the web page at the location of the anchor HTML element. Thus, the displayed image in the rendered web page functions as a link. In this example, the download attributes may be included in the anchor HTML element of the web page when the web page is downloaded, thereby avoiding the need for executable instructions to modify the web page when it is first rendered by client 100. Drag-and-drop download module 326, discussed above, is executed when a drag-and-drop is performed on an element having download attributes.

In some embodiments, responding to the drag and drop of the displayed web page element includes determining that the displayed web page element includes download attributes, and downloading the referenced content from the host to the target application in accordance with the download attributes (650). For example, drag-and-drop download module 326 responds to the drag and drop of the displayed web page element by: first determining that the displayed web page element includes download attributes 334, and then downloading the referenced content 422 from the host/server 202 to target application 342, in accordance with download attributes 334.

In some embodiments, a plurality of displayed web page elements reference content stored at a respective host external to the computer system and have respective download attributes (660), and other displayed web page elements do not have download attributes (662). For example, a number of email attachment icons displayed in an email web page reference content stored at a respective host/server 202 external to client 100 and have respective download attributes 334. Continuing this example, other displayed web page elements of the same web page, such as links to advertisements, do not have download attributes.

In some embodiments, when any of the plurality of displayed web page elements that have download attributes are dragged and dropped to a respective displayed drop location, corresponding to a respective target application distinct from the browser application, the computer system responds to the drag and drop of the web page element by downloading the referenced content from the respective host to the target application in accordance with the download attributes (670). For example, when any of the displayed email attachment icons in the aforementioned email web page are dragged and dropped to a respective displayed drop location corresponding to the desktop of client 100, drag-and-drop download module 326 responds to the drag and drop of the web page element by downloading the corresponding email attachment (i.e., the referenced content 442) from respective host/server 202 to the desktop (i.e., target application 342) in accordance with the download attributes of the dragged-and-dropped email attachment icon.

In some embodiments, in response to a drag and drop of a respective web page element that references content stored at a respective host external to the computer system and that does not include said download attributes, the computer system copies the respective web page element to the target application without copying the content referenced by the respective web page element (680). For example, drag-and-drop download module 326, in response to a drag and drop of a respective web page element (e.g., a link to an advertisement) that references content 422 stored at a respective host/server 202 external to client 100 and that does not include download attributes 334, copies the respective web page element to target application 342, without copying content 422 referenced by the respective web page element.

In some embodiments, the file name specified in the download attributes is a suggested or advisory file name, rather than a mandatory file name. For example, when the referenced content is downloaded, the user may be given the option of changing the file name to something other than the specified file name. As another example, if the downloaded content is to be stored at a location (e.g., a folder, a directory) where another file already has a name that matches the specified file name, the computer system may propose a different file name (e.g., by appending numbers to the file name before the file extension) in order to avoid a file name conflict.

Although some of various drawings illustrate a number of logical stages in a particular order, stages which are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. The embodiments were chosen and described in order to best explain the principles of the invention and its practical applications, to thereby enable others skilled in the art to best utilize the invention and various embodiments with various modifications as are suited to the particular uses contemplated. However, the illustrative discussions above are not intended to be exhaustive or to limit the invention to the precise forms disclosed. Many modifications and variations are possible in view of the above teachings.

1. A method comprising:
at a computer system having one or more processors and memory storing one or more programs executed by the one or more processors:
rendering a web page using a browser application;
wherein the web page includes a displayed web page element referencing content stored at a host external to the computer system; and
wherein rendering the web page includes modifying the displayed web page element to add one or more distinct download attributes to the displayed element;
displaying a browser application user interface, including the rendered web page; and
responding to a drag and drop of the displayed web page element to a displayed drop location corresponding to a target application at the computer system and distinct from the browser application by:
executing content downloading instructions of the browser application so as to download the referenced content from the host to the target application in accordance with the download attributes.

2. The method of claim 1, wherein the displayed web page element referencing the content stored at the host external to the computer system comprises a first displayed web page element;
further including, when the browser application renders the web page, executing one or more instructions in the web page to mark one or more displayed web page elements in the web page, the one or more marked web page elements including the first displayed web page element;
wherein each marked web page element references content stored at a respective host external to the computer system; and
wherein each marked web page element references a respective target file name and is marked to indicate that the content referenced by the marked web page element is to be downloaded to a file at the computer system, the file having the respective target file name, when the marked web page element is dragged and dropped to a displayed drop location corresponding to a respective target application distinct from the browser application.

3. The method of claim 2, including, responding to a drag and drop of a respective marked web page element of the one or more marked web page elements to the displayed drop location corresponding to the respective target application by copying content referenced by the respective marked web page element to a file, stored at the computer system, having the respective target file name.

4. The method of claim 2, including, responding to a drag and drop of a respective marked web page element of the one or more marked web page elements to the displayed drop location corresponding to the respective target application by copying content referenced by the respective marked web page element to a file, stored at the computer system, having a name corresponding to the respective target file name.

5. The method of claim 1, wherein responding to the drag and drop of the displayed web page element includes:
generating a notification of a corresponding event; and
in response to the notification, causing the browser application to download the content referenced by the displayed element to the target application.

6. The method of claim 1, wherein the web page includes a plurality of displayed web page elements and each of a subset of the plurality of displayed web page elements references respective content stored at a respective host external to the computer system;
and wherein rendering the web page using the browser application includes:
modifying a first displayed web page element in the subset of displayed web page elements to add one or more distinct download attributes to the first displayed web page element; and
forgoing modification of a second displayed web page element in the subset of displayed web page elements.

7. The method of claim 1, wherein the one or more distinct download attributes are selected from a group consisting of:
a type of the content,
a target file name, and
a URL that identifies a source of the content.

8. The method of claim 7, wherein rendering the web page further includes executing a script that adds an event listener to the displayed web page element, wherein the event listener is configured to invoke an event handler in response to a drag and drop of the displayed web page element.

9. The method of claim 1, wherein the web page includes a plurality of displayed web page elements and each of a subset of the plurality of displayed web page elements references respective content stored at a respective host external to the computer system; and
the method further includes:
detecting a drag and drop of a first displayed web page element of said subset of displayed web page elements to a respective displayed drop location corresponding to a respective target application distinct from the browser application;
in response to the drag and drop of the first displayed web page element, determining whether the first displayed web page element has download attributes;
in accordance with a determination that the first displayed web page element has download attributes, downloading the respective referenced content from the respective host to the respective target application in accordance with the download attributes.

10. The method of claim 9, further including:
detecting a drag and drop of a second displayed web page element of said subset of displayed web page elements to a respective displayed drop location corresponding to a respective target application distinct from the browser application;
in response to the drag and drop of the second displayed web page element, determining whether the second displayed web page element has download attributes;
in accordance with a determination that the second displayed web page element does not have download attributes, copying the second displayed web page element to the target application without copying the respective content referenced by the second web page element.

11. The method of claim 1, wherein the web page provides access to an online messaging application and includes an online communication, and the displayed web page element corresponds to content attached to the online communication.

12. The method of claim 1, wherein the target application is selected from the group consisting of: a desktop application, a folder application, a file manager application, a document generating application, and a media generating application.

13. An electronic device comprising a display, one or more processors, and memory storing one or more programs for execution by the one or more processors, the one or more programs including instructions that when executed by the one or more processors cause the electronic device to:
render a web page using a browser application;
wherein the web page includes a displayed web page element referencing content stored at a host external to the computer system; and
wherein rendering the web page includes modifying the displayed web page element to add one or more distinct download attributes to the displayed element;
display a browser application user interface, including the rendered web page; and
respond to a drag and drop of the displayed web page element to a displayed drop location corresponding to a target application at the electronic device and distinct from the browser application by:
executing content downloading instructions of the browser application so as to download the referenced content from the host to the target application in accordance with the download attributes.

14. The electronic device of claim 13, wherein the displayed web page element referencing the content stored at the host external to the device comprises a first displayed web page element;
the one or more programs further include instructions for executing one or more instructions in the web page, while rendering the web page, to mark one or more displayed web page elements in the web page, the one or more marked web page elements including the first displayed web page element;
wherein each marked web page element references content stored at a respective host external to the device; and
wherein each marked web page element references a respective target file name and is marked to indicate that the content referenced by the marked web page element is to be downloaded to a file at the device, the file having the respective target file name, when the marked web page element is dragged and dropped to a displayed drop location corresponding to a respective target application distinct from the browser application.

15. The electronic device of claim 14, wherein the one or more programs further include instructions for responding to a drag and drop of a respective marked web page element of the one or more marked web page elements to the displayed drop location corresponding to the respective target application by copying content referenced by the respective marked web page element to a file, stored at the device, having the respective target file name.

16. The electronic device of claim 14, wherein the one or more programs further include instructions for responding to a drag and drop of a respective marked web page element of the one or more marked web page elements to the displayed drop location corresponding to the respective target application by copying content referenced by the respective marked web page element to a file, stored at the device, having a name corresponding to the respective target file name.

17. The electronic device of claim 13, wherein the instructions to respond to the drag and drop of the displayed web page element include:
instructions to generate a notification of a corresponding event; and
instructions to respond to the notification by causing the browser application to download the content referenced by the displayed element to the target application.

18. A non-transitory computer readable storage medium storing one or more programs for execution by one or more processors in an electronic device with a display, the one or more programs including instructions that when executed by the one or more processors cause the electronic device to:
render a web page using a browser application;
wherein the web page includes a displayed web page element referencing content stored at a host external to the computer system; and
wherein rendering the web page includes modifying the displayed web page element to add one or more distinct download attributes to the displayed element;
display a browser application user interface, including the rendered web page; and
respond to a drag and drop of the displayed web page element to a displayed drop location corresponding to a target application at the electronic device and distinct from the browser application by:
executing content downloading instructions of the browser application so as to download the referenced content from the host to the target application in accordance with the download attributes.

19. The non-transitory computer readable storage medium of claim 18, wherein the displayed web page element referencing the content stored at the host external to the electronic device comprises a first displayed web page element;
the one or more programs further include instructions for executing one or more instructions in the web page, while rendering the web page, to mark one or more displayed web page elements in the web page, the one or more marked web page elements including the first displayed web page element;
wherein each marked web page element references content stored at a respective host external to the electronic device; and
wherein each marked web page element references a respective target file name and is marked to indicate that the content referenced by the marked web page element is to be downloaded to a file at the electronic device, the file having the respective target file name, when the marked web page element is dragged and dropped to a displayed drop location corresponding to a respective target application distinct from the browser application.

20. The non-transitory computer readable storage medium of claim 19, wherein the one or more programs further include instructions for responding to a drag and drop of a respective marked web page element of the one or more marked web page elements to the displayed drop location corresponding to the respective target application by copying content referenced by the respective marked web page element to a file, stored at the electronic device, having the respective target file name.

21. The non-transitory computer readable storage medium of claim 19, wherein the one or more programs further include instructions for responding to a drag and drop of a respective marked web page element of the one or more marked web page elements to the displayed drop location corresponding to the respective target application by copying content referenced by the respective marked web page element to a file, stored at the electronic device, having a name corresponding to the respective target file name.

22. The non-transitory computer readable storage medium of claim 18, wherein the instructions to respond to the drag and drop of the displayed web page element include:
instructions to generate a notification of a corresponding event; and
instructions to respond to the notification by causing the browser application to download the content referenced by the displayed element to the target application.
